(19) United States
(12) Patent Application Publication
(10) Pub. No.: US 2024/0137117 A1
(43) Pub. Date: Apr. 25, 2024

(54) OPTICAL TRANSMISSION PATH MONITORING DEVICE AND OPTICAL TRANSMISSION PATH MONITORING METHOD

(71) Applicant: NEC Corporation, Tokyo (JP)

(72) Inventor: Takehiro NAKANO, Tokyo (JP)

(73) Assignee: NEC Corporation, Tokyo (JP)

(21) Appl. No.: 18/379,985

(22) Filed: Oct. 12, 2023

(30) Foreign Application Priority Data
Oct. 19, 2022 (JP) 2022-168056

(51) Int. Cl. H04B 10/077; H04B 10/079

(52) U.S. Cl. CPC H04B 10/0775; H04B 10/0793

(57) ABSTRACT

An optical transmission path monitoring device according to the present disclosure includes a monitoring light generation circuit configured to generate first monitoring light, and send the first monitoring light to an optical transmission path, a time synchronization circuit configured to perform time synchronization with an opposite monitoring device connected to an opposite side of the optical transmission path, a light reception circuit configured to receive first returned light acquired by turning back the first monitoring light in a turnback circuit inserted in the optical transmission path, and second returned light acquired by multiple turning back, in the turnback circuit, second monitoring light sent by the opposite monitoring device, and a time control circuit configured to control a sending time of the first monitoring light by use of positional information of the turnback circuit.

This application is based upon and claims the benefit of priority from Japanese Patent Application No. 2022-168056, filed on Oct. 20, 2022, the disclosure of which is incorporated herein in its entirety by reference.

### TECHNICAL FIELD

The present disclosure relates to an optical transmission path monitoring device and an optical transmission path monitoring method, and, particularly, relates to an optical transmission path monitoring device and an optical transmission path monitoring method that are used in a long-distance optical transmission system.

### BACKGROUND ART

In a long-distance optical transmission system such as a submarine optical transmission system, there is known a system that monitors, by use of level fluctuation of monitoring light of a specific wavelength band, a state of an optical transmission path including an optical repeater, an optical fiber, and the like. One example of such a system that monitors an optical transmission path is described in PTL 1 (Japanese Patent Application Laid-open Publication No. 2002-062217).

A related optical transmission path monitoring system described in PTL 1 includes an optical transmission path monitoring device for an uplink, an optical transmission path having an uplink and a downlink, an optical transmission path monitoring device for a downlink, and a signal light source for an uplink. Further, the related optical transmission path monitoring system includes a wavelength multiplexer that wavelength-multiplexes signal light from the signal light source, and probe light for optical fiber monitoring or probe light for optical repeater monitoring from the optical transmission path monitoring device for an uplink.

In the related optical transmission path monitoring system, the signal light and the probe light are partly split by an optical fiber coupler connected to an output unit of each optical repeater, and further, only the probe light is reflected by a wavelength selective reflection device. The reflected probe light is input again to the optical fiber coupler, sent to a downlink via the optical fiber coupler, and input to the optical transmission path monitoring device for an uplink. Herein, in the related optical transmission path monitoring system, a different wavelength is allocated to monitoring probe light for an uplink and a downlink.

### SUMMARY

As described above, in the related optical transmission path monitoring system, a different wavelength is allocated to monitoring light for an uplink and a downlink. However, in order to minimize a used band of monitoring light on a wavelength band of an optical transmission path, it is preferable to use monitoring light of the same wavelength band at both a local station and an opposite station.

In this case, in order that pieces of monitoring light sent from both stations are not mixed, it is necessary to sequentially perform a monitoring operation of, for example, after completing measurement by monitoring light sent from the local station, sending monitoring light from the opposite station and starting measurement. Thus, a required time for monitoring a state of an optical transmission path increases in an optical transmission system.

In this way, there has been a problem that, in an optical transmission system, it is difficult to efficiently monitor a state of an optical transmission path, while minimizing a used band of monitoring light.

An exemplary object of the disclosure is to provide an optical transmission path monitoring device and an optical transmission path monitoring method that solve the above-described problem that, in an optical transmission system, it is difficult to efficiently monitor a state of an optical transmission path, while minimizing a used band of monitoring light.

An optical transmission path monitoring device according to the present disclosure includes: a monitoring light generation means for generating first monitoring light, and sending the first monitoring light to an optical transmission path; a time synchronization means for performing time synchronization with an opposite monitoring device connected to an opposite side of the optical transmission path; a light reception means for receiving first returned light acquired by turning back the first monitoring light in a turnback unit inserted in the optical transmission path, and second returned light acquired by multiple turning back, in the turnback unit, second monitoring light sent out by the opposite monitoring device; and a time control means for controlling a sending time of the first monitoring light by use of positional information of the turnback unit.

An optical transmission path monitoring method according to the present disclosure includes: performing time synchronization with an opposite side of an optical transmission path; generating first monitoring light, and sending the first monitoring light to the optical transmission path; receiving first returned light acquired by turning back the first monitoring light in a middle of the optical transmission path, and second returned light acquired by multiple turning back, in a middle of the optical transmission path, second monitoring light sent from the opposite side; and controlling a sending time of the first monitoring light by use of information of a position where the first monitoring light and the second monitoring light are turned back.

An optical transmission path monitoring device and an optical transmission path monitoring method according to the present disclosure are able to efficiently monitor a state of an optical transmission path, while minimizing a used band of monitoring light, in an optical transmission system.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an optical transmission path monitoring device according to the present disclosure;

FIG. 2 is a block diagram illustrating a configuration of an optical repeater used together with the optical transmission path monitoring device according to the present disclosure;

FIG. 3 is a diagram schematically illustrating a configuration of an optical transmission path monitoring system including the optical transmission path monitoring device according to the present disclosure;

FIG. 4A is a diagram chronologically illustrating an optical pulse received by the optical transmission path monitoring device according to the present disclosure;

FIG. 4B is a diagram chronologically illustrating an optical pulse received by the optical transmission path monitoring device according to the present disclosure in another case;

FIG. 5 is a flowchart for describing an optical transmission path monitoring method according to the present disclosure;

FIG. 6 is a block diagram illustrating a configuration of an optical transmission path monitoring device according to the present disclosure;

FIG. 7 is a flowchart for describing an optical transmission path monitoring method according to the present disclosure;

FIG. 8 is a block diagram illustrating a configuration of an optical transmission path monitoring device according to the present disclosure; and

FIG. 9 is a flowchart for describing an optical transmission path monitoring method according to the present disclosure.

### EXAMPLE EMBODIMENT

Example embodiments according to the present disclosure are described below with reference to the drawings.

### First Example Embodiment

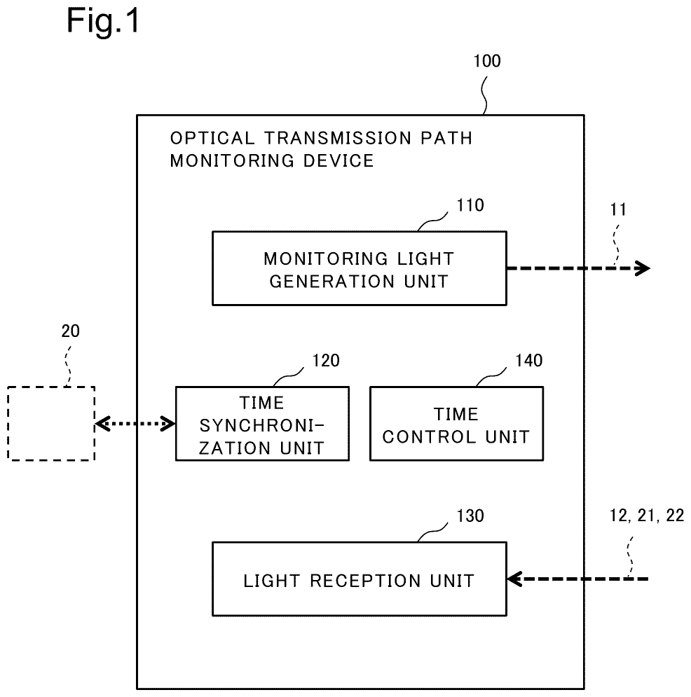

FIG. 1 is a block diagram illustrating a configuration of an optical transmission path monitoring device 100 according to a first example embodiment of the present disclosure. The optical transmission path monitoring device 100 includes a monitoring light generation unit (monitoring light generation means) 110, a time synchronization unit (time synchronization means) 120, a light reception unit (light reception means) 130, and a time control unit (time control means) 140. The optical transmission path monitoring device 100 is preferably used in a long-distance optical transmission system such as a submarine optical transmission system.

The monitoring light generation unit 110 generates first monitoring light 11, and sends the first monitoring light 11 to an optical transmission path. The time synchronization unit 120 performs time synchronization with an opposite monitoring device 20 connected to an opposite side of the optical transmission path. The light reception unit 130 receives first returned light 12 acquired by turning back the first monitoring light 11 in a turnback unit inserted in the optical transmission path, and second returned light 22 acquired by multiply turning back, in the turnback unit, second monitoring light 21 sent by the opposite monitoring device 20. Then, the time control unit 140 controls a sending time of the first monitoring light 11 by use of positional information of the turnback unit.

In this way, the optical transmission path monitoring device 100 according to the present example embodiment includes a configuration in which the time control unit 140 controls a sending time of the first monitoring light 11 by use of positional information of the turnback unit. Arrival time information of the first returned light 12 of a local station and the second monitoring light 21 and the second returned light 22 of an opposite station is acquired from the positional information of the turnback unit. Herein, the arrival time information is information relating to an arrival time based on the sending time.

Since the arrival time depends on the sending time, the arrival time can be controlled (shifted) by controlling the sending time. Therefore, by using the positional information of the turnback unit, even when both a local station and an opposite station use monitoring light of the same wavelength band, monitoring of an optical transmission path can be performed from both stations in parallel. In other words, the optical transmission path monitoring device 100 according to the present example embodiment can efficiently monitor a state of an optical transmission path, while minimizing a used band of monitoring light, in an optical transmission system.

The monitoring light generation unit 110 typically generates an optical pulse as the first monitoring light 11. The embodiment is not limited thereto, but the monitoring light generation unit 110 may include a configuration that generates, as the first monitoring light 11, an optical signal generating light for a shorter time than a time interval of returned light corresponding to an interval of the turnback unit. Moreover, an optical signal including a plurality of pulse sequences or a modulation signal generating light for a certain time may be used as the first monitoring light 11. Note that, the first monitoring light 11 and the second monitoring light 21 may be different in a type of an optical signal.

The time synchronization unit 120 may include a configuration that performs time synchronization by use of a method utilizing a line dedicated for synchronization, a network time protocol (NTP) method, or the like.

The time control unit 140 may include a configuration including a storage unit that previously stores positional information of the turnback unit, and a sending time control unit that controls a time at which the monitoring light generation unit 110 sends the first monitoring light 11.

Herein, the time control unit 140 may include a configuration that controls a sending time of the first monitoring light 11 in such a way that the first returned light 12 and the second returned light 22 do not overlap in time.

Moreover, a wavelength of the first monitoring light 11 and a wavelength of the second monitoring light 21 may both be included in a wavelength band of a wavelength selection unit provided in the turnback unit.

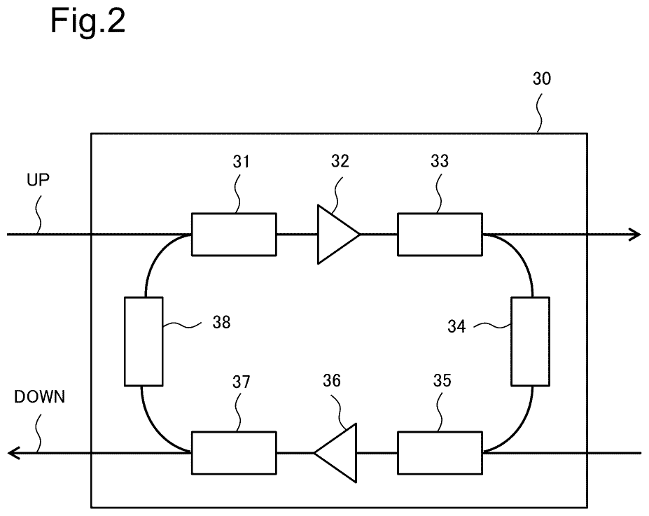

FIG. 2 illustrates one example of an optical repeater including a turnback unit. An optical repeater 30 includes an optical amplifier 32 for an uplink, an optical amplifier 36 for a downlink, optical filters 34 and 38 as wavelength selection units, and optical couplers 31, 33, 35, and 37. Herein, the optical filters 34 and 38 and the optical couplers 31, 33, 35, and 37 constitute a turnback unit (loopback unit). Note that, a passage wavelength band of each of the optical filters 34 and 38 is set in such a way as to include a wavelength of monitoring light.

In the optical repeater 30, monitoring light input from the uplink is turned back (loopback) to the downlink via the optical coupler 31, the optical coupler 33, the optical filter 34, the optical coupler 35, and the optical coupler 37. Herein, since the passage wavelength band of the optical filter 38 is set in such a way as to include a wavelength of monitoring light, monitoring light split by the optical coupler 37 is coupled to the uplink by the optical coupler 31 via the optical filter 38. In other words, monitoring light input from the uplink is multiply (doubly) turned back. The same also applies to monitoring light input from the downlink. In this way, the optical repeater 30 includes a turnback unit (loopback unit) that turns back monitoring light of the same wavelength band in both uplink and downlink directions. Note that, while it is assumed in the above description that the turnback unit (loopback unit) is included in the optical repeater, the embodiment is not limited thereto, but, for example, the turnback unit (loopback unit) may be inserted in an optical transmission path between optical repeaters.

Next, an operation of the optical transmission path monitoring device 100 according to the present example embodiment is described.

The time control unit 140 included in the optical transmission path monitoring device 100 may include a configuration that controls a sending time of the first monitoring light 11 in such a way that the sending time of the first monitoring light 11 is different from a sending time of the second monitoring light 21 by a sending time difference. Herein, the sending time difference may be longer than a delay time in the turnback unit, and shorter than a turnback time in which the second monitoring light travels back and forth on an optical transmission path between adjacent turnback units.

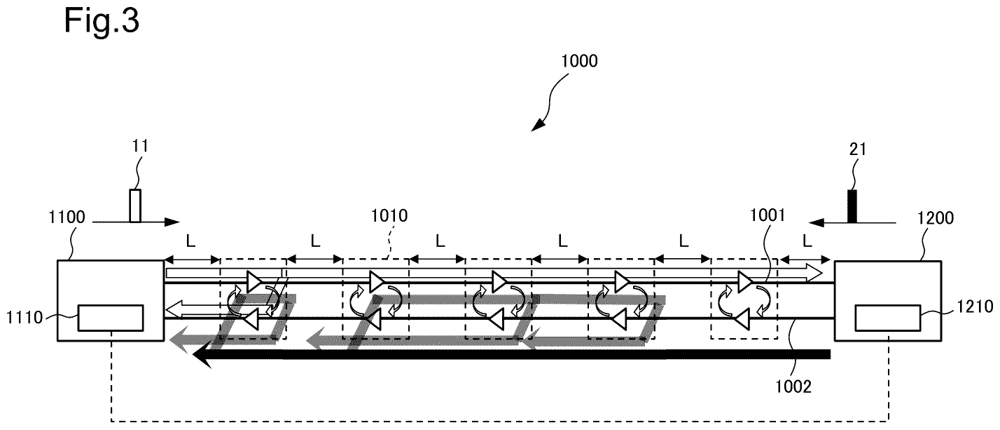

The operation of the optical transmission path monitoring device according to the present example embodiment is described below in further detail. FIG. 3 schematically illustrates a configuration of an optical transmission path monitoring system 1000 including a first monitoring device 1100, and a second monitoring device 1200 being an opposite monitoring device.

The configuration of the first monitoring device 1100 is similar to the configuration of the optical transmission path monitoring device 100 described above (refer to FIG. 1). A monitoring light generation unit included in the first monitoring device 1100 generates the first monitoring light 11, and sends the first monitoring light 11 to a first optical transmission path 1001.

Similarly, to the optical transmission path monitoring device 100, the second monitoring device 1200 includes at least a second monitoring light generation unit (second monitoring light generation means), a second time synchronization unit (second time synchronization means), and a second light reception unit (second light reception means). Herein, the second monitoring light generation unit generates the second monitoring light 21, and sends the second monitoring light 21 to a second optical transmission path 1002. A second time synchronization unit 1210 performs time synchronization with the first monitoring device 1100. Then, the second light reception unit receives third returned light acquired by turning back the second monitoring light 21 in a turnback unit, and fourth returned light acquired by multiply turning back the first monitoring light 11 in the turnback unit.

Herein, a first time synchronization unit 1110 included in the first monitoring device 1100 and the second time synchronization unit 1210 included in the second monitoring device 1200 perform time synchronization of the first monitoring device 1100 and the second monitoring device 1200. Note that, FIG. 3 illustrates a configuration in which the turnback unit is included in an optical repeater 1010.

In the optical transmission path monitoring system 1000, the first monitoring device 1100 and the second monitoring device 1200 installed at both opposite stations transmit the first monitoring light 11 and the second monitoring light 21. Then, the first monitoring device 1100 and the second monitoring device 1200 each receive an optical pulse turned back from a turnback unit (loopback unit) mounted in the optical repeater 1010 installed in an optical transmission path.

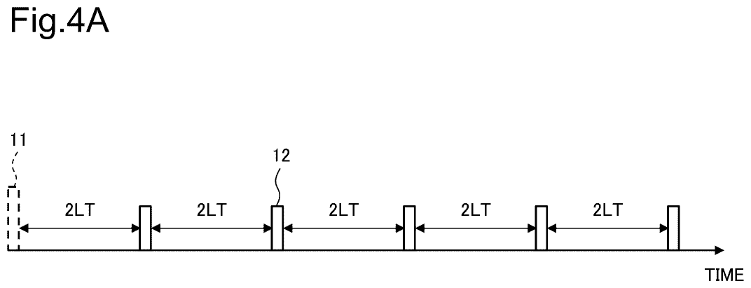

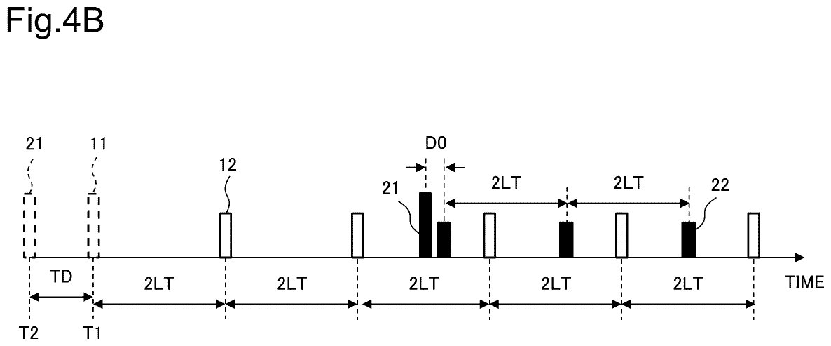

FIG. 4A chronologically illustrates an optical pulse based on the first monitoring light 11 received by the first monitoring device 1100. The first monitoring device 1100 receives the first returned light 12 acquired by turning back the first monitoring light 11 in each turnback unit. In this instance, the first monitoring device 1100 receives the first returned light 12 at an interval time 2 LT required for the first monitoring light 11 to travel back and forth over an installation distance L of each of the optical repeaters 1010. Then, the first monitoring device 1100 monitors states of each of the optical repeaters 1010, the first optical transmission path 1001, and the second optical transmission path 1002, by use of a level fluctuation of the first returned light 12.

FIG. 4B chronologically illustrates an optical pulse received by the first monitoring device 1100 when the second monitoring device 1200 also transmits the second monitoring light 21 and performs a monitoring operation. The first monitoring device 1100 receives, in addition to the first returned light 12, the second monitoring light 21, and the second returned light 22 acquired by multiply turning back the second monitoring light 21 in the turnback unit. Herein, since a wavelength of the first monitoring light 11 and a wavelength of the second monitoring light 21 are both included in the same wavelength band, wavelengths of the first returned light 12 and the second returned light 22 are also included in the same wavelength band.

In this case, as described above, the time control unit included in the first monitoring device 1100 includes a configuration that controls a sending time T1 of the first monitoring light 11 in such a way that the sending time T1 of the first monitoring light 11 is different from a sending time T2 of the second monitoring light 21 by a sending time difference TD. Herein, the sending time difference TD is longer than a delay time DO in the turnback unit, and shorter than a turnback time 2 LT in which the second monitoring light travels back and forth on an optical transmission path between adjacent turnback units. Therefore, the first returned light 12 that the first monitoring device 1100 uses for monitoring, the second monitoring light 21 sent by the second monitoring device 1200 being an opposite monitoring device, and the second returned light 22 based on the second monitoring light 21 do not overlap in time. As a result, even when both a local station and an opposite station use monitoring light of the same wavelength band, monitoring of an optical transmission path can be performed from both stations of the optical transmission path in parallel. In other words, the optical transmission path monitoring system 1000 according to the present example embodiment can efficiently monitor a state of an optical transmission path, while minimizing a used band of monitoring light, in an optical transmission system.

In the above description, installation distance of each of the optical repeaters 1010 has been assumed to be the same distance L in any section. However, the embodiment is not limited thereto, but, even when the optical repeaters 1010 include sections of different distances, the optical transmission path monitoring device 100 and the optical transmission path monitoring system 1000 according to the present example embodiment may be applied. Moreover, while a case has been described above where the optical transmission path monitoring system 1000 includes the first monitoring device 1100, and the second monitoring device 1200 being an opposite monitoring device, the embodiment is not limited thereto, but the optical transmission path monitoring system 1000 may include an optical device that receives and processes optical signals from three or more places, such as an optical add-drop multiplexer (OADM).

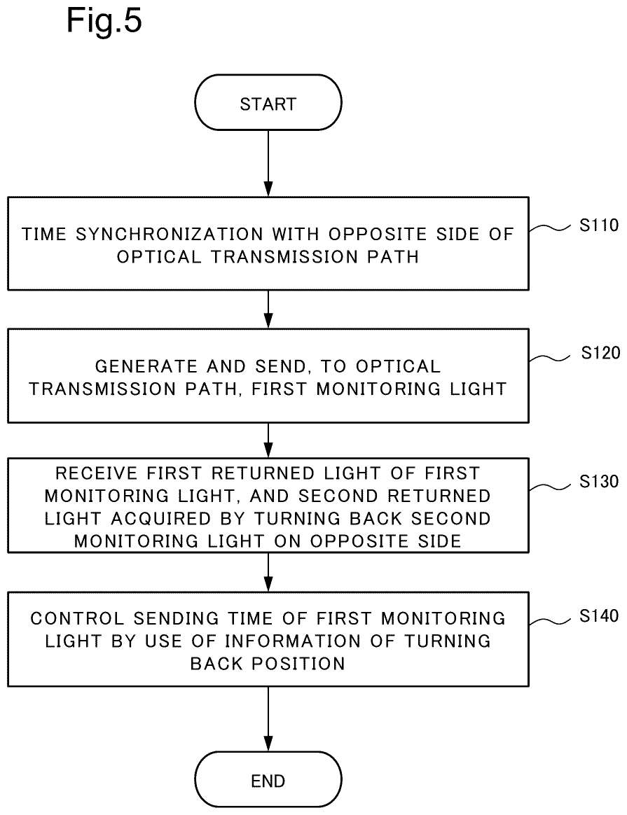

Next, an optical transmission path monitoring method according to the present example embodiment is described by use of a flowchart illustrated in FIG. 5.

In the optical transmission path monitoring method according to the present example embodiment, first, time synchronization is performed with an opposite side of an optical transmission path (step S110). Subsequently, first monitoring light is generated, and the first monitoring light is sent to the optical transmission path (step S120). Then, first returned light acquired by turning back the first monitoring light in a middle of the optical transmission path, and second returned light acquired by multiply turning back, in a middle of the turnback unit, second monitoring light sent from by the opposite side are received (step S130). In this instance, a sending time of the first monitoring light is controlled by use of information of a position where the first monitoring light and the second monitoring light are turned back (step S140).

In this way, the optical transmission path monitoring method according to the present example embodiment includes a configuration that controls a sending time of the first monitoring light by use of information of a position where monitoring light is turned back. An arrival time of first returned light of a local station, and arrival times of second monitoring light and second returned light of an opposite station can be controlled (shifted) by controlling the sending time. Therefore, by using information of a position where monitoring light is turned back, even when both a local station and an opposite station use monitoring light of the same wavelength band, monitoring of an optical transmission path can be performed from both stations in parallel. In other words, the optical transmission path monitoring method according to the present example embodiment can efficiently monitor a state of an optical transmission path, while minimizing a used band of monitoring light, in an optical transmission system.

Herein, controlling a sending time of the first monitoring light described above may include controlling a sending time of the first monitoring light in such a way that first returned light and second returned light do not overlap in time.

Moreover, controlling a sending time of the first monitoring light may include controlling a sending time of the first monitoring light in such a way that the sending time of the first monitoring light is different from a sending time of the second monitoring light by a sending time difference. Herein, the sending time difference may be longer than a delay time when the second returned light is turned back, and shorter than a turnback time in which the second monitoring light travels back and forth on an optical transmission path between the adjacent positions where the second monitoring light is turned back.

Note that, it may be assumed that a wavelength of the first monitoring light and a wavelength of the second monitoring light are both included in a wavelength band of wavelength selection when the first monitoring light and the second returned light are turned back.

As described above, the optical transmission path monitoring device 100, the optical transmission path monitoring system 1000, and the optical transmission path monitoring method according to the present example embodiment can efficiently monitor a state of an optical transmission path, while minimizing a used band of monitoring light, in an optical transmission system.

### Second Example Embodiment

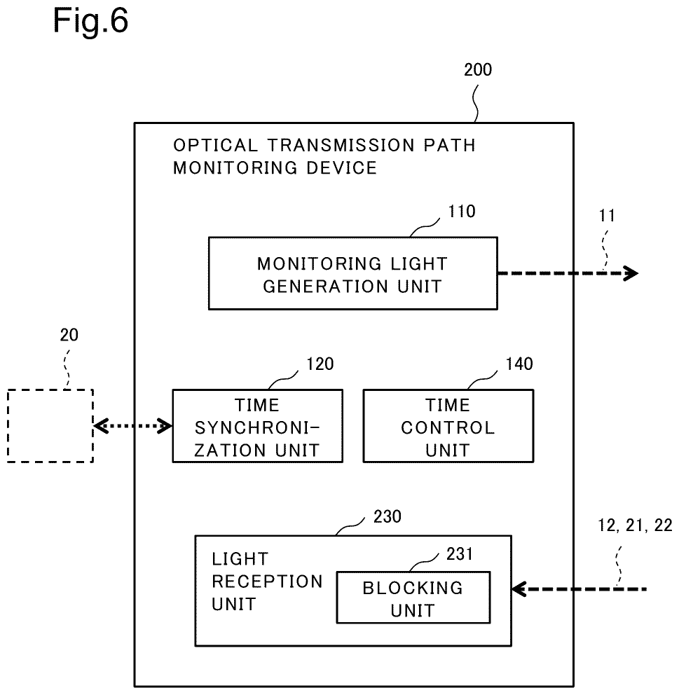

Next, a second example embodiment according to the present disclosure is described. FIG. 6 illustrates a configuration of an optical transmission path monitoring device 200 according to the present example embodiment. The optical transmission path monitoring device 200 includes a monitoring light generation unit (monitoring light generation means) 110, a time synchronization unit (time synchronization means) 120, a light reception unit (light reception means) 230, and a time control unit (time control means) 140. The optical transmission path monitoring device 200 is preferably used in a long-distance optical transmission system such as a submarine optical transmission system.

The monitoring light generation unit 110 generates first monitoring light 11, and sends the first monitoring light 11 to an optical transmission path. The time synchronization unit 120 performs time synchronization with an opposite monitoring device 20 connected to an opposite side of the optical transmission path. The light reception unit 230 receives first returned light 12 acquired by turning back the first monitoring light 11 in a turnback unit inserted in the optical transmission path, and second returned light 22 acquired by multiply turning back, in the turnback unit, second monitoring light 21 sent by the opposite monitoring device 20. Then, the time control unit 140 controls a sending time of the first monitoring light 11 by use of positional information of the turnback unit.

The configuration up to here is similar to the configuration of the optical transmission path monitoring device 100 according to the first example embodiment. The optical transmission path monitoring device 200 according to the present example embodiment includes a configuration in which the light reception unit 230 includes a blocking unit (blocking means) 231. Herein, the blocking unit 231 blocks input light in a time in which any one of the second monitoring light 21 and the second returned light 22 arrives at the light reception unit 230. For example, an optical shutter, an optical filter, or the like being capable of time control may be used as the blocking unit 231.

In this way, the optical transmission path monitoring device 200 according to the present example embodiment includes a configuration in which the time control unit 140 controls a sending time of the first monitoring light 11 by use of information of positional information of a turnback unit. Thus, an arrival time of the first returned light 12 of a local station, and arrival times of the second monitoring light 21 and the second returned light 22 of an opposite station may be controlled (shifted). Further, an influence of the second monitoring light 21 and the second returned light 22 sent by the opposite monitoring device 20 may be eliminated by the blocking unit 231. Therefore, even when both a local station and an opposite station use monitoring light of the same wavelength band, monitoring of an optical transmission path may be performed from both stations in parallel. In other words, the optical transmission path monitoring device 200 according to the present example embodiment may efficiently monitor a state of an optical transmission path, while minimizing a used band of monitoring light, in an optical transmission system.

Note that, a configuration including, instead of the blocking unit 231, a passage unit (passage means) that causes input light to pass in a time in which the first returned light 12 arrives at the light reception unit 230 may also be provided.

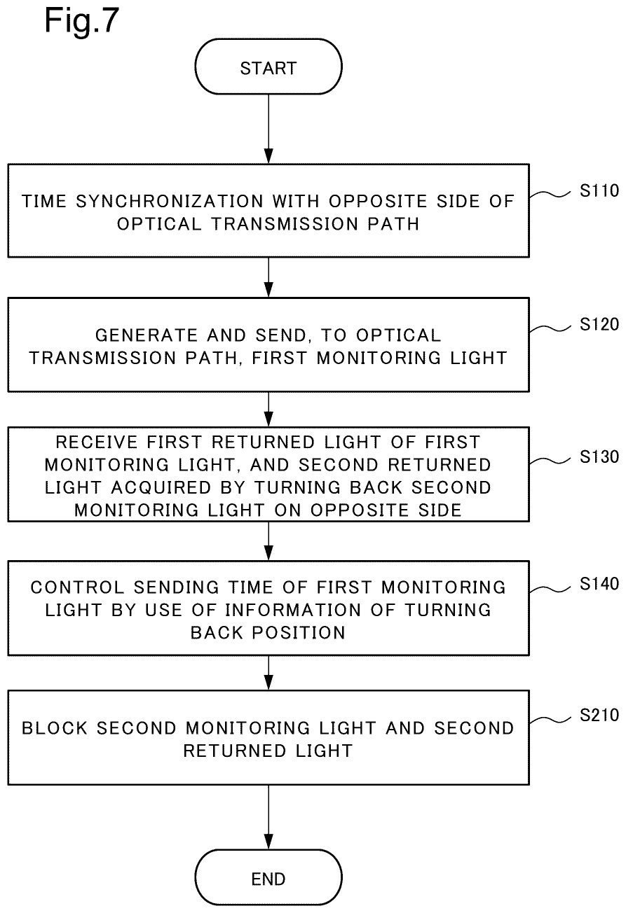

Next, an optical transmission path monitoring method according to the present example embodiment is described by use of a flowchart illustrated in FIG. 7.

In the optical transmission path monitoring method according to the present example embodiment, first, time synchronization is performed with an opposite side of an optical transmission path (step S110). Subsequently, first monitoring light is generated, and the first monitoring light is sent to the optical transmission path (step S120). Then, first returned light acquired by turning back the first monitoring light in a middle of the optical transmission path, and second returned light acquired by multiply turning back, in a middle of the turnback unit, second monitoring light sent from by the opposite side are received (step S130). In this instance, a sending time of the first monitoring light is controlled by use of information of a position where the first monitoring light and the second monitoring light are turned back (step S140).

The steps up to here are similar to those in the optical transmission path monitoring method according to the first example embodiment. The optical transmission path monitoring method according to the present example embodiment includes a configuration further including blocking second monitoring light and second returned light in a time in which any one of the second monitoring light and the second returned light is received (step S210).

In this way, the optical transmission path monitoring method according to the present example embodiment includes a configuration that controls a sending time of first monitoring light by use of information of a position where monitoring light is turned back. Thus, an arrival time of first returned light of a local station, and arrival times of second monitoring light and second returned light of an opposite station may be controlled (shifted). Further, an influence of the second monitoring light and the second returned light sent from an opposite side may be eliminated by blocking the second monitoring light and the second returned light. Therefore, even when both a local station and an opposite station use monitoring light of the same wavelength band, monitoring of an optical transmission path may be performed from both stations in parallel. In other words, the optical transmission path monitoring method according to the present example embodiment may efficiently monitor a state of an optical transmission path, while minimizing a used band of monitoring light, in an optical transmission system.

Note that, instead of blocking the second monitoring light and the second returned light, the first returned light may be passed in a time in which the first returned light is received.

As described above, the optical transmission path monitoring device 200 and the optical transmission path monitoring method according to the present example embodiment may efficiently monitor a state of an optical transmission path, while minimizing a used band of monitoring light, in an optical transmission system.

### Third Example Embodiment

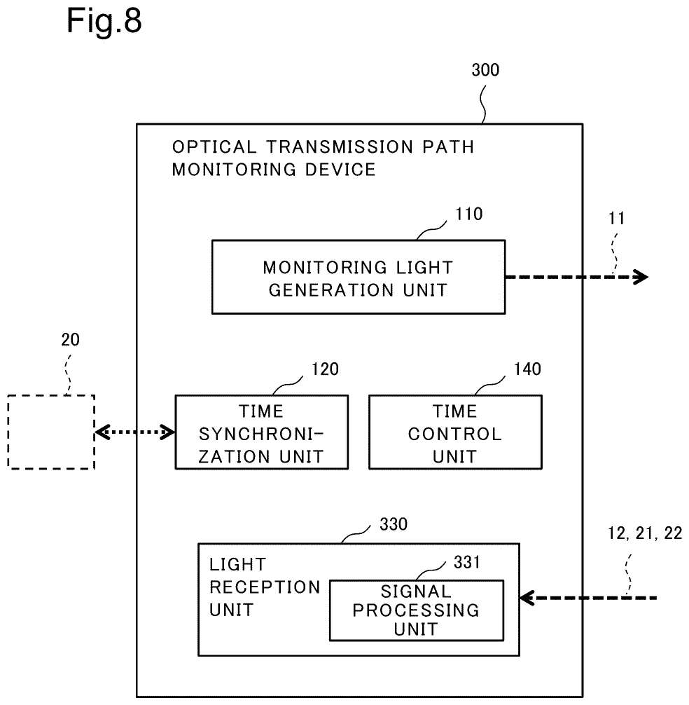

Next, a third example embodiment according to the present disclosure is described below. FIG. 8 illustrates a configuration of an optical transmission path monitoring device 300 according to the present example embodiment. The optical transmission path monitoring device 300 includes a monitoring light generation unit (monitoring light generation means) 110, a time synchronization unit (time synchronization means) 120, a light reception unit (light reception means) 330, and a time control unit (time control means) 140. The optical transmission path monitoring device 300 is preferably used in a long-distance optical transmission system such as a submarine optical transmission system.

The monitoring light generation unit 110 generates first monitoring light 11, and sends the first monitoring light to an optical transmission path. The time synchronization unit 120 performs time synchronization with an opposite monitoring device 20 connected to an opposite side of the optical transmission path. The light reception unit 330 receives first returned light 12 acquired by turning back the first monitoring light 11 in a turnback unit inserted in the optical transmission path, and second returned light 22 acquired by multiply turning back, in the turnback unit, second monitoring light 21 sent by the opposite monitoring device 20. Then, the time control unit 140 controls a sending time of the first monitoring light 11 by use of positional information of the turnback unit.

The configuration up to here is similar to the configuration of the optical transmission path monitoring device 100 according to the first example embodiment. The optical transmission path monitoring device 300 according to the present example embodiment includes a configuration in which the light reception unit 330 generates first returned light by converting the first returned light 12 into an electric signal, and generates second returned light by converting the second monitoring light 21 and the second returned light 22 into an electric signal. In this case, as the optical transmission path monitoring device 300 illustrated in FIG. 8, the light reception unit 330 may include a configuration including a signal processing unit (signal processing means) 331 that receives a first returned light signal and a second returned light signal, and eliminates the second returned light signal. For example, a filter circuit may be used as the signal processing unit 331.

In this way, the optical transmission path monitoring device 300 according to the present disclosure includes a configuration in which the time control unit 140 controls a sending time of the first monitoring light 11 by use of positional information of a turnback unit. Thus, an arrival time of the first returned light 12 of a local station, and arrival times of the second monitoring light 21 and the second returned light 22 of an opposite station can be controlled (shifted). Further, an influence of the second monitoring light 21 and the second returned light 22 sent by the opposite monitoring device 20 can be eliminated by the signal processing unit 331. Therefore, even when both a local station and an opposite station use monitoring light of the same wavelength band, monitoring of an optical transmission path can be performed from both stations in parallel. In other words, the optical transmission path monitoring device 300 according to the present example embodiment can efficiently monitor a state of an optical transmission path, while minimizing a used band of monitoring light, in an optical transmission system.

Note that, instead of the signal processing unit 331, a signal processing unit (signal processing means) that receives a first returned light signal and a second returned light signal, and extracts the first returned light signal may be used.

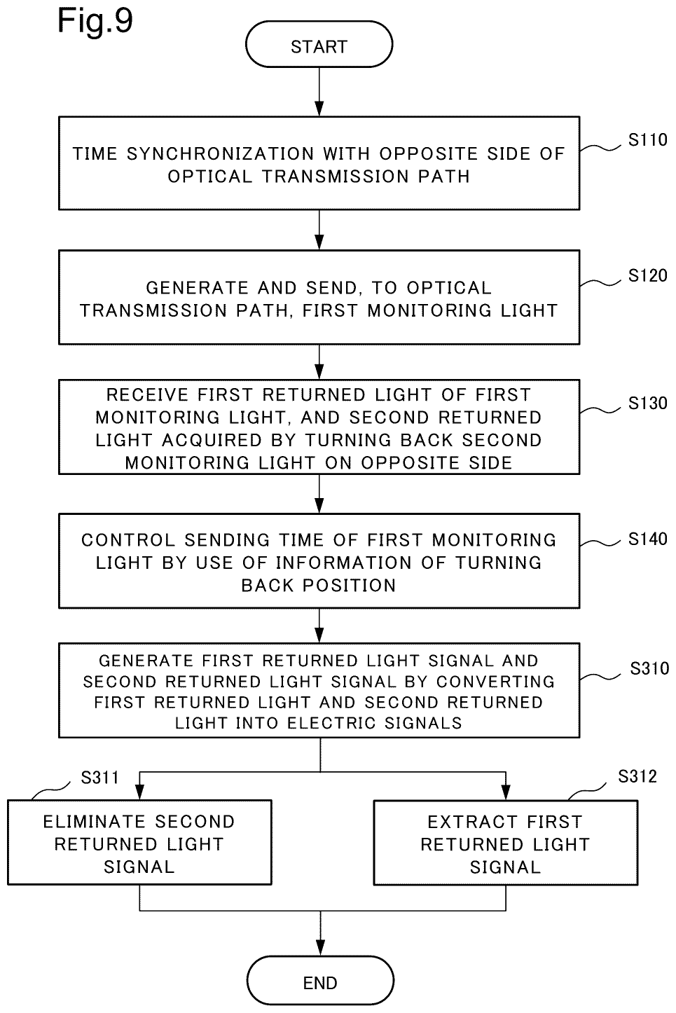

Next, an optical transmission path monitoring method according to the present example embodiment is described by use of a flowchart illustrated in FIG. 9.

In the optical transmission path monitoring method according to the present example embodiment, first, time synchronization is performed with an opposite side of an optical transmission path (step S110). Subsequently, first monitoring light is generated, and the first monitoring light is sent to the optical transmission path (step S120). Then, first returned light acquired by turning back the first monitoring light in a middle of the optical transmission path, and second returned light acquired by multiply turning back, in a middle of the turnback unit, second monitoring light sent from by the opposite side are received (step S130). In this instance, a sending time of the first monitoring light is controlled by use of information of a position where the first monitoring light and the second monitoring light are turned back (step S140).

The steps up to here are similar to those in the optical transmission path monitoring method according to the first example embodiment. The optical transmission path monitoring method according to the present example embodiment includes a configuration further including generating a first returned light signal by converting first returned light into an electric signal, and generating a second returned light signal by converting second monitoring light and the second returned light into an electric signal (step S310). In this case, a first returned light signal and a second returned light signal may be received, and the second returned light signal may be eliminated (step S311). The embodiment is not limited thereto, but a first returned light signal and a second returned light signal may be received, and the first returned light signal may be extracted (step S312).

In this way, the optical transmission path monitoring method according to the present example embodiment includes a configuration that controls a sending time of first monitoring light by use of information of a position where monitoring light is turned back. Thus, an arrival time of first returned light of a local station, and arrival times of second monitoring light and second returned light of an opposite station can be controlled (shifted). Further, a second returned light signal acquired by converting second monitoring light and second returned light into an electric signal is eliminated, or a first returned light signal acquired by converting first returned light into an electric signal is extracted. Thereby, an influence of the second monitoring light and the second returned light sent from an opposite side can be eliminated. Therefore, even when both a local station and an opposite station use monitoring light of the same wavelength band, monitoring of an optical transmission path can be performed from both stations in parallel.

As described above, the optical transmission path monitoring device 300 and the optical transmission path monitoring method according to the present example embodiment can efficiently monitor a state of an optical transmission path, while minimizing a used band of monitoring light, in an optical transmission system.

Some or all of the above-described example embodiments may also be described as the following supplementary notes, but are not limited to these supplementary.

### (Supplementary Note 1)

An optical transmission path monitoring device including: a monitoring light generation means for generating first monitoring light, and sending the first monitoring light to an optical transmission path; a time synchronization means for performing time synchronization with an opposite monitoring device connected to an opposite side of the optical transmission path; a light reception means for receiving first returned light acquired by turning back the first monitoring light in a turnback unit inserted in the optical transmission path, and second returned light acquired by multiple turning back, in the turnback unit, second monitoring light sent by the opposite monitoring device; and a time control means for controlling a sending time of the first monitoring light by use of positional information of the turnback unit.

### (Supplementary Note 2)

The optical transmission path monitoring device according to supplementary note 1, wherein the time control means controls a sending time of the first monitoring light in such a way that the first returned light and the second returned light do not overlap time.

### (Supplementary Note 3)

The optical transmission path monitoring device according to supplementary note 1 or 2, wherein the time control means controls a sending time of the first monitoring light in such a way that the sending time of the first monitoring light is different from a sending time of the second monitoring light by a sending time difference, and the sending time difference is longer than a delay time in the turnback unit, and shorter than a turnback time in which the second monitoring light travels back and forth on the optical transmission path between the adjacent turnback units.

### (Supplementary Note 4)

The optical transmission path monitoring device according to supplementary note 1 or 2, wherein the light reception means includes a blocking means for blocking input light in a time in which any one of the second monitoring light and the second returned light arrives at the light reception means.

### (Supplementary Note 5)

The optical transmission path monitoring device according to supplementary note 1 or 2, wherein the light reception means includes a passage means for causing input light to pass in a time in which the first returned light arrives at the light reception unit.

### (Supplementary Note 6)

The optical transmission path monitoring device according to supplementary note 1 or 2, wherein the light reception means generates a first returned light signal by converting the first returned light into an electric signal, and generates a second returned light signal by converting the second monitoring light and the second returned light into an electric signal.

### (Supplementary Note 7)

The optical transmission path monitoring device according to supplementary note 6, wherein the light reception means includes a signal processing means for receiving the first returned light signal and the second returned light signal, and eliminating the second returned light signal.

### (Supplementary Note 8)

The optical transmission path monitoring device according to supplementary note 6, wherein the light reception means includes a signal processing means for receiving the first returned light signal and the second returned light signal, and extracting the first returned light signal.

### (Supplementary Note 9)

The optical transmission path monitoring device according to supplementary note 1 or 2, wherein a wavelength of the first monitoring light and a wavelength of the second monitoring light are both included in a wavelength band of a wavelength selection unit provided in the turnback unit.

### (Supplementary Note 10)

An optical transmission path monitoring method including: performing time synchronization with an opposite side of an optical transmission path; generating first monitoring light, and sending the first monitoring light to the optical transmission path; receiving first returned light acquired by turning back the first monitoring light in a middle of the optical transmission path, and second returned light acquired by multiple turning back, in a middle of the turnback unit, second monitoring light sent from by the opposite side; and controlling a sending time of the first monitoring light by use of information of a position where the first monitoring light and the second monitoring light are turned back.

### (Supplementary Note 11)

The optical transmission path monitoring method according to supplementary note 10, wherein the controlling a sending time of the first monitoring light includes controlling a sending time of the first monitoring light in such a way that the first returned light and the second returned light do not overlap in time.

### (Supplementary Note 12)

The optical transmission path monitoring method according to supplementary note 10 or 11, wherein the controlling a sending time of the first monitoring light includes controlling a sending time of the first monitoring light in such a way that the sending time of the first monitoring light is different from a sending time of the second monitoring light by a sending time difference, and the sending time difference is longer than a delay time when the second returned light is turned back, and shorter than a turnback time in which the second monitoring light travels back and forth on the optical transmission path between the adjacent positions where the second monitoring light is turned back.

### (Supplementary Note 13)

The optical transmission path monitoring method according to supplementary note 10 or 11, further including blocking the second monitoring light and the second returned light in a time in which any one of the second monitoring light and the second returned light is received.

### (Supplementary Note 14)

The optical transmission path monitoring method according to supplementary note 10 or 11, further including causing the first returned light to pass in a time in which the first returned light is received.

### (Supplementary Note 15)

The optical transmission path monitoring method according to supplementary note 10 or 11, further including: generating a first returned light signal by converting the first returned light into an electric signal; and generating a second returned light signal by converting the second monitoring light and the second returned light into an electric signal.

### (Supplementary Note 16)

The optical transmission path monitoring method according to supplementary note 15, further including: receiving the first returned light signal and the second returned light signal; and eliminating the second returned light signal.

### (Supplementary Note 17)

The optical transmission path monitoring method according to supplementary note 15, further including: receiving the first returned light signal and the second returned light signal; and extracting the first returned light signal.

### (Supplementary Note 18)

The optical transmission path monitoring method according to supplementary note 10 or 11, wherein a wavelength of the first monitoring light and a wavelength of the second monitoring light are both included in a wavelength band of wavelength selection when the first monitoring light and the second monitoring light are turned back.

### (Supplementary Note 19)

An optical transmission path monitoring system including a first monitoring device being the optical transmission path monitoring device according to supplementary note 1 or 2, and a second monitoring device being the opposite monitoring device.

### (Supplementary Note 20)

The optical transmission path monitoring system according to supplementary note 19, wherein the second monitoring device includes at least a second monitoring light generation means for generating the second monitoring light, and sending the second monitoring light to the second optical transmission path, a second time synchronization means for performing time synchronization with the first monitoring device, and a second light reception means for receiving third returned light acquired by turning back the second monitoring light in the turnback unit, and fourth returned light acquired by multiple turning back the first monitoring light in the turnback unit.

The previous description of embodiments is provided to enable a person skilled in the art to make and use the present disclosure.

Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

### REFERENCE SIGNS LIST

100, 200, 300 Optical transmission path monitoring device
110 Monitoring light generation unit
120 Time synchronization unit
130, 230, 330 Light reception unit
140 Time control unit
231 Blocking unit
331 Signal processing unit
1000 Optical transmission path monitoring system
1001 First optical transmission path
1002 Second optical transmission path
1010 Optical repeater
1100 First monitoring device
1110 First time synchronization unit
1200 Second monitoring device
1210 Second time synchronization unit
20 Opposite monitoring device
30 Optical repeater
31, 33, 35, 37 Optical coupler
32, 36 Optical amplifier
34, 38 Optical filter

1. An optical transmission path monitoring device comprising:
a monitoring light generation circuit configured to generate first monitoring light, and send the first monitoring light to an optical transmission path;
a time synchronization circuit configured to perform time synchronization with an opposite monitoring device connected to an opposite side of the optical transmission path;
a light reception circuit configured to receive first returned light acquired by turning back the first monitoring light in a turnback circuit inserted in the optical transmission path, and second returned light acquired by multiple turning back, in the turnback circuit, second monitoring light sent by the opposite monitoring device; and
a time control circuit configured to control a sending time of the first monitoring light by use of positional information of the turnback circuit.

2. The optical transmission path monitoring device according to claim 1, wherein
the time control circuit controls a sending time of the first monitoring light in such a way that the first returned light and the second returned light do not overlap in time.

3. The optical transmission path monitoring device according to claim 1, wherein
the time control circuit controls a sending time of the first monitoring light in such a way that the sending time of the first monitoring light is different from a sending time of the second monitoring light by a sending time difference, and
the sending time difference is longer than a delay time in the turnback circuit, and shorter than a turnback time in which the second monitoring light travels back and forth on the optical transmission path between the adjacent turnback circuits.

4. The optical transmission path monitoring device according to claim 1, wherein
the light reception circuit includes a blocking circuit configured to block input light in a time in which any one of the second monitoring light and the second returned light arrives at the light reception circuit.

5. The optical transmission path monitoring device according to claim 1, wherein
the light reception circuit includes a passage circuit configured to cause input light to pass in a time in which the first returned light arrives at the light reception circuit.

6. The optical transmission path monitoring device according to claim 1, wherein
the light reception circuit generates a first returned light signal by converting the first returned light into an electric signal, and generates a second returned light signal by converting the second monitoring light and the second returned light into an electric signal.

7. The optical transmission path monitoring device according to claim 6, wherein
the light reception circuit includes a signal processing circuit configured to receive the first returned light signal and the second returned light signal, and eliminate the second returned light signal.

8. The optical transmission path monitoring device according to claim 6, wherein
the light reception circuit includes a signal processing circuit configured to receive the first returned light signal and the second returned light signal, and extract the first returned light signal.

9. The optical transmission path monitoring device according to claim 1, wherein
a wavelength of the first monitoring light and a wavelength of the second monitoring light are both included in a wavelength band of a wavelength selection circuit provided in the turnback circuit.

10. An optical transmission path monitoring method comprising:
performing time synchronization with an opposite side of an optical transmission path;
generating first monitoring light, and sending the first monitoring light to the optical transmission path;
receiving first returned light acquired by turning back the first monitoring light in a middle of the optical transmission path, and second returned light acquired by multiple turning back, in a middle of the optical transmission path, second monitoring light sent from by the opposite side; and
controlling a sending time of the first monitoring light by use of information of a position where the first monitoring light and the second monitoring light are turned back.

11. The optical transmission path monitoring method according to claim 10, wherein
the controlling a sending time of the first monitoring light includes controlling a sending time of the first monitoring light in such a way that the first returned light and the second returned light do not overlap in time.

12. The optical transmission path monitoring method according to claim 10, wherein
the controlling a sending time of the first monitoring light includes controlling a sending time of the first monitoring light in such a way that the sending time of the first monitoring light is different from a sending time of the second monitoring light by a sending time difference, and
the sending time difference is longer than a delay time when the second returned light is turned back, and shorter than a turnback time in which the second monitoring light travels back and forth on the optical transmission path between the adjacent positions where the second monitoring light is turned back.

13. The optical transmission path monitoring method according to claim 10, further comprising blocking the second monitoring light and the second returned light in a time in which any one of the second monitoring light and the second returned light is received.

14. The optical transmission path monitoring method according to claim 10, further comprising causing the first returned light to pass in a time in which the first returned light is received.

15. The optical transmission path monitoring method according to claim 10, further comprising:
generating a first returned light signal by converting the first returned light into an electric signal; and
generating a second returned light signal by converting the second monitoring light and the second returned light into an electric signal.

16. The optical transmission path monitoring method according to claim 15, further comprising:
receiving the first returned light signal and the second returned light signal; and
eliminating the second returned light signal.

17. The optical transmission path monitoring method according to claim 15, further comprising:
receiving the first returned light signal and the second returned light signal; and
extracting the first returned light signal.

18. The optical transmission path monitoring method according to claim 10, wherein a wavelength of the first monitoring light and a wavelength of the second monitoring light are both included in a wavelength band of wavelength selection when the first monitoring light and the second monitoring light are turned back.

19. An optical transmission path monitoring system comprising:
an optical transmission path monitoring device including
a monitoring light generation circuit configured to generate first monitoring light, and send the first monitoring light to an optical transmission path,
a time synchronization circuit configured to perform time synchronization with an opposite monitoring device connected to an opposite side of the optical transmission path,
a light reception circuit configured to receive first returned light acquired by turning back the first monitoring light in a turnback circuit inserted in the optical transmission path, and second returned light acquired by multiple turning back, in the turnback circuit, second monitoring light sent by the opposite monitoring device, and
a time control circuit configured to control a sending time of the first monitoring light by use of positional information of the turnback circuit; and
the opposite monitoring device.

20. The optical transmission path monitoring system according to claim 19, wherein the opposite monitoring device includes at least
a second monitoring light generation circuit configured to generate the second monitoring light, and send the second monitoring light to the optical transmission path,
a second time synchronization circuit configured to perform time synchronization with the optical transmission path monitoring device, and
a second light reception circuit configured to receive third returned light acquired by turning back the second monitoring light in the turnback circuit, and fourth returned light acquired by multiple turning back the first monitoring light in the turnback circuit.
